(19) United States
(12) Patent Application Publication
(10) Pub. No.: US 2008/0013942 A1
(43) Pub. Date: Jan. 17, 2008

(54) Photographic information logging device and method

(76) Inventor: Mary Brown, Destin, FL (US)

Correspondence Address: WILLIAM H. HOLLIMON, 215 SOUTH MONROE STREET, 2ND FLOOR, TALLAHASSEE, FL, 32301, US

(21) Appl. No.: 11/485,662

(22) Filed: Jul. 13, 2006

(51) Int. Cl. G03B 17/24

(52) U.S. Cl. 396/310

(57) ABSTRACT

The present invention relates to a photographic information logging device for recording photographic information. The photographic information logging device includes a logging sheet that is removably attachable to a camera and further includes a transparent cover to protect information recorded on the logging sheet. The logging sheet includes pre-printed lines to facilitate the recording of photographic information.

### BACKGROUND OF THE INVENTION

This invention relates to generally to a device and method for logging information about individual exposures taken on a camera, and more particularly to a device and method that simply and easily allow the recordation of relevant information on a logging sheet that is directly and removably attachable to a camera.

Many people purchase and use one-time-use disposable cameras during vacations, holidays, and family gatherings. These people are generally not professional photographers and the disposable cameras used are typically non-adjustable as to shutter speed, aperture, and other photographic parameters. Further, these cameras typically do not have the capability to imprint a time/date stamp directly on the photograph, or the capability to record audio commentary regarding a particular picture taken.

Thus, one significant drawback of these cameras is that they provide no easy mechanism for allowing the camera user to keep track of important information regarding any (or all) of the pictures taken with the disposable camera. Many users, upon having the film within the disposable camera developed, have difficulty recalling the specific information about individual pictures. For example, such a person may not recall the time or date a picture was taken, the name of the person or persons captured in the picture, or the name or location of the physical scenery captured. Further, such users may want additional copies of only one or two of the pictures on a roll of film, but cannot remember the particular film frame or frames to request for additional copies.

It is known in the art to provide a photographic log in which information related to individual pictures may be recorded. In U.S. Pat. No. 5,795,090, one such photographic log is disclosed, and includes a spiral ring notebook containing a plurality of pages, with each page containing a plurality of removable labels upon which information related to a photograph may be recorded. The primary disadvantage of this prior art is that the spiral notebook is completely independent from the camera and requires the user to keep up with and manage two separate devices—the camera and the notebook. Further, it is not useful where a single camera is used by more than one person, or groups of persons. For example, many families, at activities such as wedding receptions where large numbers of disparate persons may attend, place disposable cameras at tables where a wedding reception is held. Guests are encouraged to take pictures of the festivities for the benefit of the bride and groom who usually do not get to spend much time with any one particular group of attendees. Such disposable cameras are often used by multiple persons over the course of an event. In this type of circumstance, it is difficult, if not impossible, to also keep track of a separate notebook for logging photographic information. Moreover, because there are typically many such cameras available for guest's use, multiple notebooks would also be required, as well as a system for matching notebooks to disposable cameras. These complications severely restrict the utility of logging systems that require the use of a log that is separate from the camera.

It is also known in the art to provide a container that is either attachable to a lens cover, or that replaces a lens cover, in which photographic information logging sheets may be stored. U.S. Pat. No. 4,721,971 discloses such a container. However, this device suffers from the disadvantages of being bulky, cumbersome, and expensive to produce. In addition, it requires a camera to have a lens cap or other suitable surface for mounting. Most disposable cameras do not have lens caps and otherwise are not suitable for receiving a bulky container. Further, it is cumbersome to use in that it requires manipulation of a hard plastic cover, and the management of multiple pieces of paper used to log photographic information. Also, it does not allow viewing of the photographic log without opening the container and sifting through multiple entries. This makes it cumbersome for users to determine what photographs have already been taken. For example, in the wedding reception situation discussed above, to determine if a picture of Uncle Joe and Aunt Sally has already been taken requires opening the container and sorting through all log sheets to determine if such a picture has already been taken.

### SUMMARY

It is therefore an object of the present invention to provide a device and method that allows for the convenient, easy, and removable attachment of a photographic logging device that allows a user to contemporaneously record individual photograph related information. It is another object of the present invention to provide a photographic logging device that is directly attachable to a camera, without the need to include a bulky container to hold logged information. It is another object of the present invention to provide a transparent cover that overlays logged information and protects this information from smudging.

The present invention is a compact device that includes a printable surface for receiving information related to a photograph, with the printable surface being removably attachable to a camera surface via a non-permanent adhesive. The present invention further includes a transparent cover sheet that serves to cover the printable surface and protect it from smudging by a camera user's fingers or from rain and that is easily repositioned to allow for logging of information.

### DRAWINGS

These and other features, aspects, and advantages of the present invention will become better understood with regard to the following description, appended claims, and accompanying drawings wherein:

FIG. 1 is an isometric, front view of the present invention

FIG. 2 is a rear view of the present invention;

FIG. 3 is a front view of the present invention;

### DESCRIPTION

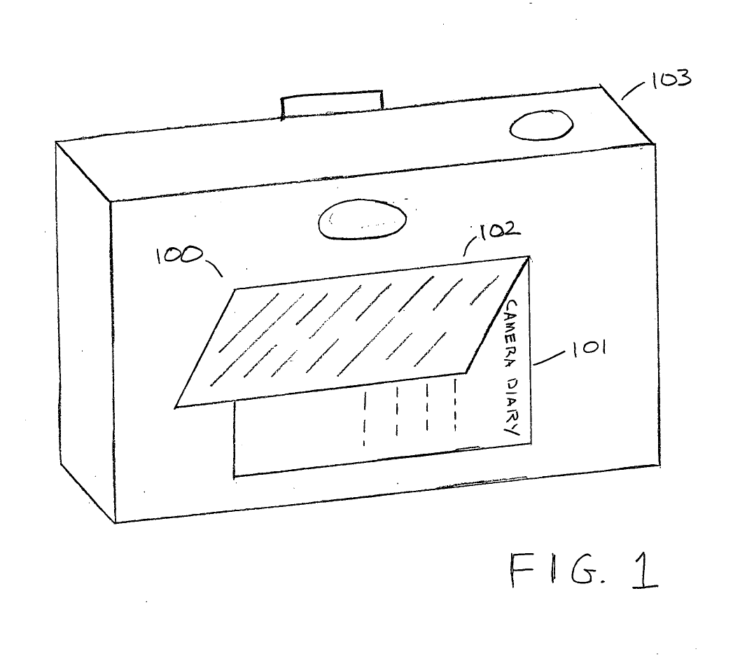

Referring to FIG. 1, photographic information logging device 100 is shown and includes logging sheet 101 and cover 102. Logging sheet 100 may be made from paper, a thin plastic, or other similar material that is suitable for receiving writing from a pen or pencil. Logging sheet 101 is preferably rectangular in shape and sized to fit the back of a standard disposable camera 103. Cover 102 is preferably a clear plastic material that is connected to logging sheet 101 along a long edge of logging sheet 101. Cover 102 is attached to logging sheet 101 by non-permanent adhesive or by binding, or may be integrally formed with logging sheet 101. Cover 102 is biased such that it normally rests in a position proximate to logging sheet 101. This bias may be provided by the construction of cover 102, or by including a small amount of non-permanent adhesive on the face of cover 102 in contact with logging sheet 101. In FIG. 1, cover 102 is shown in a partially opened condition.

Prior to the logging of photographic information, cover 102 is normally positioned such that it is proximate to logging sheet 101. In this position, a user may view logged information without lifting cover 102. Additionally, when cover 102 is in the closed position, information recorded on logging sheet 101 is protected from finger prints and other smudges to the recorded information. To record information, a user lifts cover 102, records information, and then allows cover 102 to return to its normal position.

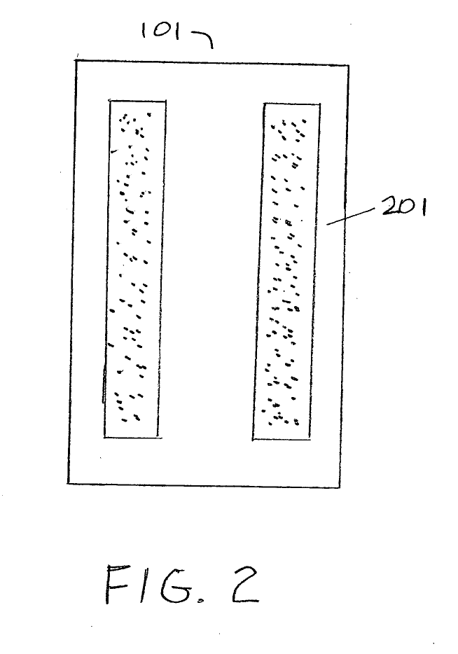

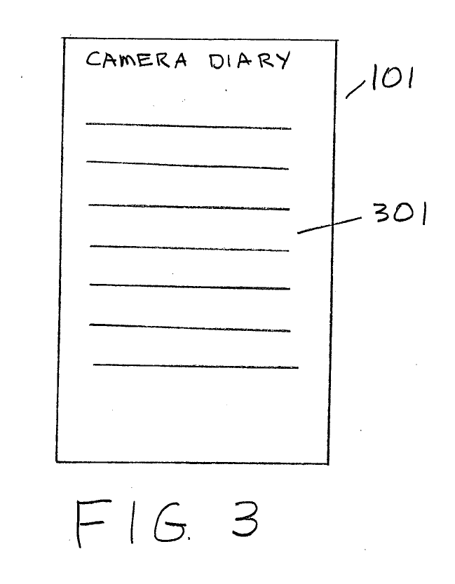

Referring to FIG. 2, a rear view of logging sheet 101 is shown. Non-permanent adhesive 201 allows the removable attachment of logging sheet 101 to disposable camera 103. Referring to FIG. 3, logging sheet 101 is shown with cover 102 removed. Logging sheet 101 is provided with pre-printed lines 301 which facilitate the logging of photographic information. Preferably, the number of pre-printed lines 301 is variable to conform with the number of film frames included within the disposable camera. For example, photographic information logging device 100 can be produced with 12, 24, 27 or 36, or any other number of pre-printed lines 301.

In a preferred embodiment, photographic information logging device 100 is produced in the form of a pad containing multiple, discrete photographic information logging devices 100, all of which are secured together via non-permanent adhesive 201. In this embodiment, a user removes one photographic information logging device 100 from the pad by releasing non-permanent adhesive 201 from the underlying photographic information logging device 100 and places it on a camera.

### Advantages

The photographic information logging device 100 of the present invention offers numerous advantages. First, it provides a simple and effective means to record information related to photographs taken. It is non-bulky, non-obtrusive, and does not affect the use or operation of a camera to which it is attached. It provides a simple and secure way to protect logged information while allowing a user to view this information.

Although the illustrative embodiments of the present invention have been described herein with reference to the accompanying drawings, it is to be understood that the invention is not limited to those precise embodiments, and that various other changes and modifications may be affected by one skilled in the art without departing form the scope or spirit of the invention. All such changes and modifications are intended to be included within the scope of the invention as defined by the appended claims.

What is claimed is:

1. A photographic information logging device comprising:
a. a logging sheet having a front side and a back side, said front side including at least one line for logging photographic information, and said back side including a non-permanent adhesive for removably attaching said logging sheet to a camera;
b. a transparent cover, said cover connected to said logging sheet along an edge of said logging sheet, said cover biased to be normally positioned proximate to said front side of said logging sheet, while allowing said cover to be repositioned for logging of photographic information.

2. The photographic information logging device of claim 1 wherein said logging sheet front side includes at least twelve lines for logging photographic information.

3. The photographic information logging device of claim 1 wherein said transparent cover is integrally formed with said logging sheet.

4. The photographic information logging device of claim 1 wherein a plurality of said photographic information logging sheets are formed into a pad wherein a topmost photographic information logging sheet is removably attached to an underlying photographic information logging sheets by said non-permanent adhesive.

5. A method for logging photographic information comprising the steps of:
a. providing a logging sheet, said logging sheet containing at least one preprinted line for logging photographic information;
b. providing means for removably attaching said logging sheet to a camera;
c. providing a transparent cover, said cover integral to said logging sheet, biased to be positioned proximate to said logging sheet, and positionable to allow logging of photographic information.
d. providing a pad of photographic information logging sheets, said pad comprised of a plurality of photographic information logging sheets wherein a topmost photographic information logging sheet is removably attached to an underlying photographic information logging sheets.
